(19) United States
(12) Patent Application Publication
(10) Pub. No.: US 2026/0220453 A1
(43) Pub. Date: Jul. 30, 2026

(54) SYSTEMS AND METHODS FOR HIERARCHICAL MACHINE LEARNING TRAINING FOR SUBSURFACE MODELING

(71) Applicant: Chevron U.S.A. Inc., San Ramon, CA (US)

(72) Inventors: Eduardo Maldonado Cruz, Houston, TX (US); Lewis Li, Houston, TX (US); Tao Sun, Missouri City, TX (US); Julio Cesar de la Colina, Houston, TX (US)

(21) Appl. No.: 19/041,417

(22) Filed: Jan. 30, 2025

(51) Int. Cl. G06N 3/08; G01V 20/00; G06N 3/0475

(52) U.S. Cl. CPC G06N 3/08; G01V 20/00; G06N 3/0475

(57) ABSTRACT

A machine learning model is hierarchically trained to generate representations of subsurface regions. The hierarchical training of the machine learning model includes sequential training of the machine learning model using different resolutions of data (e.g., different resolutions of input subsurface representation, hard data, and/or soft data). The hierarchical training of the machine learning model utilizes a minimization framework in the latent space to match hard and soft data at multiple resolutions. The output of the hierarchically trained machine learning model is used to generate facies probability cubes for subsurface modeling or used as the subsurface model, resulting in the subsurface representation (e.g., 3D computer model of a subsurface region) including realistic geological patterns while honoring soft/hard data at multiple resolutions.

### FIELD

The present disclosure relates generally to the field of hierarchically training a machine learning model using progressively higher resolution to generate subsurface representations.

### BACKGROUND

Traditional geostatistical approaches for subsurface modeling are limited when dealing with subsurface regions that include complicated heterogeneity and non-stationary spatial distributions. Additionally, traditional geostatistical approaches may produce unrealistic results. Use of machine learning models for subsurface modeling has been limited to stationary spatial distributions, non-realistic physical information, and simplistic data honoring at a single resolution.

### SUMMARY

This disclosure relates to hierarchical machine learning training for subsurface modeling. Conditioning information, input subsurface representation information, and/or other information may be obtained. The conditioning information may define one or more conditioning characteristics within a subsurface region. The input subsurface representation information may define an input subsurface representation for modeling of the subsurface region. The input subsurface representation may define simulated subsurface configuration within a simulated subsurface region. A machine learning model may be hierarchically trained using the conditioning characteristic(s) and the input subsurface representation to generate a subsurface representation. The hierarchical training of the machine learning model may include training of the machine learning model in a sequence using progressively higher resolution. The hierarchical training of the machine learning model may include a first stage in which the machine learning model is trained using the conditioning characteristic(s) and the input subsurface representation with a first resolution and a second stage subsequent to the first stage in which the machine learning model is trained using the conditioning characteristic(s) and the input subsurface representation with a second resolution higher than the first resolution. One or more output subsurface representations for the modeling of the subsurface region may be generated using the trained machine learning model. The output subsurface representation(s) generated by the trained machine learning model may honor the conditioning characteristic(s) within the subsurface region. The modeling of the subsurface region may be performed based on the output subsurface representation(s) and/or other information.

A system for hierarchical machine learning training for subsurface modeling may include one or more electronic storage, one or more processors and/or other components. The electronic storage may store information relating to a subface region, conditioning information, information relating to conditioning characteristics, input subsurface representation information, information relating to a subsurface representation, information relating to an input subsurface representation, information relating to an output subsurface representation, information relating to a machine learning model, information relating to modeling of the subsurface region, and/or other information.

The processor(s) may be configured by machine-readable instructions. Executing the machine-readable instructions may cause the processor(s) to facilitate hierarchical machine learning training for subsurface modeling. The machine-readable instructions may include one or more computer program components. The computer program components may include one or more of a conditioning component, an input subsurface representation component, a train component, an output subsurface representation component, a modeling component, and/or other computer program components.

The conditioning component may be configured to obtain conditioning information and/or other information. The conditioning information may define one or more conditioning characteristics within a subsurface region. In some implementations, the conditioning information may include information from field exploration of the subsurface region, seismic exploration of the subsurface region, and/or production in the subsurface region.

The input subsurface representation component may be configured to obtain input subsurface representation information and/or other information. The input subsurface representation information may define one or more input subsurface representations for modeling of the subsurface region. An input subsurface representation may define simulated subsurface configuration within a simulated subsurface region.

The train component may be configured to hierarchically train a machine learning model. The machine learning model may be trained using the conditioning characteristic(s), the input subsurface representation(s), and/or other information to generate a subsurface representation. The hierarchical training of the machine learning model may include training of the machine learning model in a sequence using progressively higher resolution. The hierarchical training of the machine learning model may include a first stage in which the machine learning model is trained using the conditioning characteristic(s) and an input subsurface representation with a first resolution, a second stage subsequent to the first stage in which the machine learning model is trained using the conditioning characteristic(s) and the input subsurface representation with a second resolution higher than the first resolution, and/or other stages.

In some implementations, the machine learning model may include a generative neural network.

In some implementations, different resolutions used in the hierarchical training of the machine learning model may correspond to sizes of different subsurface features.

In some implementations, the machine-learning model may be partially trained after completion of the first stage of the hierarchical training. An output of the partially-trained machine learning model may be used as an input for the second stage of the hierarchical training.

The output subsurface representation component may be configured to generate one or more output subsurface representations for modeling of the subsurface region using the trained machine learning model. The output subsurface representation(s) generated by the trained machine learning model may honor the conditioning characteristic(s) within the subsurface region. In some implementations, multiple output subsurface representations may be generated for the modeling of the subsurface region using the trained machine learning model. In some implementations, random noise may be input into the trained machine learning model to generate the output subsurface representation(s).

The modeling component may be configured to perform modeling of the subsurface region based on the output subsurface representation(s) and/or other information. In some implementations, a facies probability cube for the subsurface region may be generated based on the multiple output subsurface representations and/or other information. Performance of the modeling of the subsurface region based on the output subsurface representation(s) may include performance of the modeling of the subsurface region based on the facies probability cube for the subsurface region. In some implementations, the modeling of the subsurface region may be performed using a multiple-point statistics simulation and/or other simulations.

In some implementations, performance of the modeling of the subsurface region based on the output subsurface representation(s) may generate one or more geologically realistic subsurface representations for the subsurface region that honor the conditioning characteristic(s) within the subsurface region at multiple levels of resolution.

In some implementations, production in the subsurface region may be facilitated based on the modeling of the subsurface region and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for hierarchical machine learning training for subsurface modeling.

FIG. 2 illustrates an example method for hierarchical machine learning training for subsurface modeling.

FIG. 3 illustrates an example process for hierarchical machine learning training for subsurface modeling.

FIG. 4 illustrates an example process for hierarchical machine learning training for subsurface modeling.

### DETAILED DESCRIPTION

The present disclosure relates to hierarchical machine learning training for subsurface modeling. A machine learning model is hierarchically trained to generate representations of subsurface regions. The hierarchical training of the machine learning model includes sequential training of the machine learning model using different resolutions of data (e.g., different resolutions of input subsurface representation, hard data, and/or soft data). The hierarchical training of the machine learning model utilizes a minimization framework in the latent space to match hard and soft data at multiple resolutions. The output of the hierarchically trained machine learning model is used to generate facies probability cubes for subsurface modeling or used as the subsurface model, resulting in the subsurface representation (e.g., 3D computer model of a subsurface region) including realistic geological patterns while honoring soft/hard data at multiple resolutions.

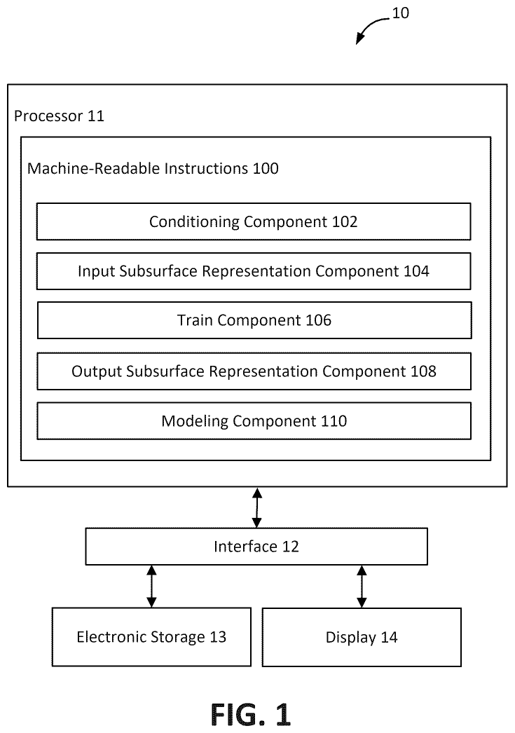

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Conditioning information, input subsurface representation information, and/or other information may be obtained by the processor 11. The conditioning information may define one or more conditioning characteristics within a subsurface region. The input subsurface representation information may define an input subsurface representation for modeling of the subsurface region. The input subsurface representation may define simulated subsurface configuration within a simulated subsurface region. A machine learning model may be hierarchically trained by the processor 11 using the conditioning characteristic(s) and the input subsurface representation to generate a subsurface representation.

The hierarchical training of the machine learning model may include training of the machine learning model in a sequence using progressively higher resolution. The hierarchical training of the machine learning model may include a first stage in which the machine learning model is trained using the conditioning characteristic(s) and the input subsurface representation with a first resolution and a second stage subsequent to the first stage in which the machine learning model is trained using the conditioning characteristic(s) and the input subsurface representation with a second resolution higher than the first resolution.

One or more output subsurface representations for the modeling of the subsurface region may be generated by the processor 11 using the trained machine learning model. The output subsurface representation(s) generated by the trained machine learning model may honor the conditioning characteristic(s) within the subsurface region. The modeling of the subsurface region may be performed by the processor 11 based on the output subsurface representation(s) and/or other information.

The electronic storage 13 may include one or more non-transitory storage media configured to electronically store information. The electronic storage 13 may store software algorithms, information determined by the processor 11, information received remotely, and/or other information that enables the system 10 to function properly. For example, the electronic storage 13 may store information relating to a subface region, conditioning information, information relating to conditioning characteristics, input subsurface representation information, information relating to a subsurface representation, information relating to an input subsurface representation, information relating to an output subsurface representation, information relating to a machine learning model, information relating to modeling of the subsurface region, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present information relating to a subface region, conditioning information, information relating to conditioning characteristics, input subsurface representation information, information relating to a subsurface representation, information relating to an input subsurface representation, information relating to an output subsurface representation, information relating to a machine learning model, information relating to modeling of the subsurface region, and/or other information.

Accurate characterization and modeling of subsurface heterogeneity are critical for efficient/optimum subsurface resource development. Traditional geostatistical approaches used for spatial continuity analysis include use of variogram models, geometric object distributions, or multiple point templates with conditional probabilities calculated from training images. However, these traditional geostatistical approaches for subsurface modeling are limited when dealing with subsurface regions that include complicated heterogeneity and non-stationary spatial distributions (statistical characteristics of subsurface properties changes between locations).

Additionally, traditional geostatistical approaches may produce unrealistic results. For example, traditional geostatistical approaches may encounter challenges while integrating critical information necessary to fully characterize subsurface heterogeneity, such as large-scale conservation of mass and momentum, element stacking patterns related to depositional sequence, changes in sediment supply, sedimental composition, confinement, and available accommodation. While existing geostatistical methods may honor hard data, the realizations may miss the geological and physical information sources and, therefore, may not be realistic. In contrast, realistic subsurface models, such as high-resolution shallow seismic, lidar scanned outcrops or physics-based models, may have difficulty integrating hard data. Use of machine learning models for subsurface modeling has been limited to stationary spatial distributions, non-realistic physical information, and simplistic data honoring at a single resolution (single scale of data collection, single level of data detail).

The present disclosure enables generation of subsurface representations that include realistic geological patterns while honoring soft/hard data at multiple resolutions. The present disclosure enables physics-based subsurface representations (3D computer models of a subsurface region generated using a physics-based process) to be used for subsurface modeling, which may in turn be used to facilitate production in subsurface regions.

A machine learning model is hierarchically trained to generate representations of subsurface regions. The machine learning model may include generative adversarial network(s) (GAN(s)) and/or other models. The hierarchical training utilizes a minimization framework in the latent space to match hard and/or soft data at progressively higher resolutions. The machine learning model may be used to generate multiple subsurface representations (realizations) that honor data with different resolutions (e.g., well logs, seismic data) while including realistic heterogeneity. The subsurface representations generated by the machine learning model may be used to generate a facies probability cube for a subsurface region, which may be used in a multiple-point statistics simulation for subsurface modeling (e.g., reservoir modeling for hydrocarbon production). The output of the present disclosure may be seamlessly integrated into the standard subsurface modeling workflow.

The use of physics-based subsurface representations to train the machine learning model ensures geological and physical consistency in the subsurface representations generated by the machine learning model. The use of hierarchical training with progressively higher resolutions results in the subsurface representations generated by the machine learning model respecting conditioning data (hard and/or soft data) at their corresponding levels of resolution. For example, seismic data may be honored during a lower-resolution stage of the hierarchical training while well log data may be honored during a higher-resolution stage of the hierarchical training. The hard and soft data are reconciled via application of a minimization framework in the latent space. The minimization framework may transform the hard and soft data and reduce the resolution, reducing/minimizing the difference between the prediction and observed hard and soft data at multiple scales during the hierarchical training.

The hierarchical training may scale the subsurface representation used for training using an exponential function, which may prioritize the creation of more subsurface representations at lower resolutions over higher resolutions. For individual stages in the hierarchical training, an encoder-decoder framework may be employed to perform the up-scaling. This framework may increase/maximize the restoration performance, ensuring that significant features are not lost during the upscaling process.

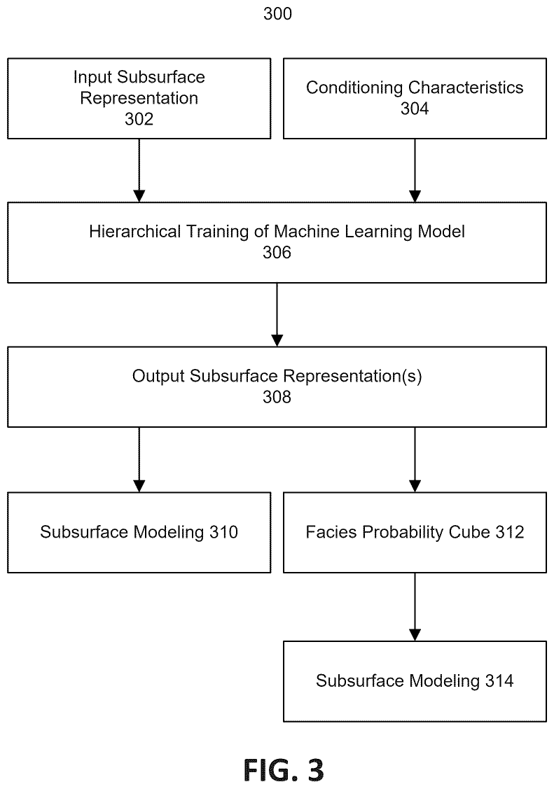

FIG. 3 illustrates an example process 300 for hierarchical machine learning training for subsurface modeling. In the process 300, training data for hierarchical training of machine learning model 306 may include an input subsurface representation 302 and conditioning characteristics 304. The input subsurface representation 302 may include a physics-based subsurface representation that defines simulated subsurface configuration within a simulated subsurface region. The input subsurface representation 302 may define values of subsurface properties as a function of location within the simulated subsurface region (e.g., array defining values of rock properties at different locations). The input subsurface representation 302 may provide the physical constraints that are needed for training the machine learning model. The conditioning characteristics 304 may define one or more conditioning characteristics within a subsurface region (target region) that are to be honored within subsurface representations generated by the machine learning model. The conditioning characteristics 304 may include hard data and/or soft data to be honored within subsurface representations generated by the machine learning model. Hard data may include direct measurement of subsurface properties (e.g., measurements from rock samples). Soft data may include data from indirect measurement of subsurface properties (e.g., measurements estimated from hard data; use of seismic data to measure acoustic impedance, from which subsurface properties are derived). The conditioning characteristics 304 may include information obtained and/or derived from field exploration of the subsurface region, seismic exploration of the subsurface region, and/or production in the subsurface region. Example conditioning characteristics may include rock types, seismic maps, well logs, and production data (e.g., well connectivity from on production data).

The hierarchical training of machine learning model 306 may include training of the machine learning model in successive stages, where the resolution of data used to train the machine learning model increases with each successive stage. The training may include selection and/or modification of hyperparameters of the machine learning model. The training may be performed until low error prediction is achieved (difference between actual output of the machine learning model and the desired/targeted output of the machine learning model is less than a threshold amount). The trained machine learning model may be used to generate one or more output subsurface representations 308. The output subsurface representation(s) 308 may define simulated subsurface configuration within the subsurface region. The output subsurface representation(s) 308 may honor the conditioning characteristics 304. Different output subsurface representations may provide different scenarios of subsurface configuration within the subsurface region. Different output subsurface representations may provide equally probable scenarios of subsurface configuration that are integrated with the conditioning characteristics 304. For example, different output subsurface representations may honor rock types found at different well locations within the subsurface region, while providing different scenarios of connectivity and heterogeneity away from the wells.

The output subsurface representation(s) 308 may be used to perform subsurface modeling 310. For example, the output subsurface representation(s) 308 themselves may be used as a 3D computer model of the subsurface region. The output subsurface representation(s) 308 may be used to generate a facies probability cube 312. One or more of the output subsurface representation(s) 308 may be used to generate the facies probability cube 312. The output subsurface representation(s) 308 to be used to generate the facies probability cube 312 may be selected by one or more users or automatically. For example, the output subsurface representation(s) 308 may be presented on an electronic display for user selection. As another example, the output subsurface representation(s) 308 may be automatically selected based on or more criteria. Different types of facies probability cube 312 may be generated for different types of rock types (e.g., low-quality, mid-quality, high-quality, shale). The facies probability cube 312 may be used to perform subsurface modeling 314. For example, the facies probability cube 312 may be used as input in a multiple-point statistics simulation or other geostatistical simulation of the subsurface region. The multiple-point statistics simulation may utilize the facies probability cube 312 to generate realistic geological models that reproduce geological patterns while retaining the flexibility to honor conditioning data at multiple resolutions.

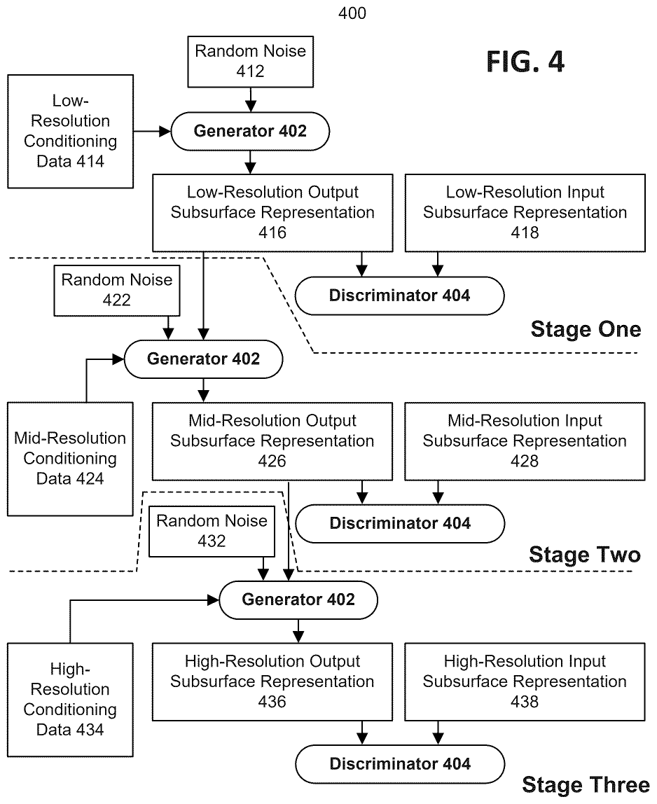

FIG. 4 illustrates an example process 400 for hierarchical machine learning training for subsurface modeling. A generative adversarial network may be trained by minimizing a loss function comprised of an adversarial term, a reconstruction term, and a term for honoring hard and/or soft data. The generative adversarial network may include a generator 402 and a discriminator 404. While the hierarchical machine learning training shown in FIG. 4 includes three stages, this is merely an example and is not meant to be limiting. Other number of stages and use of other resolutions are contemplated.

For individual stage (iteration) of the hierarchical training process, a minimization framework in the latent space may be used. The latent space may be defined with the same shape/dimensions as the subsurface representations. The minimization framework may reduce the error (difference) between the output of the generator and the conditioning data (hard and/or soft data) at the corresponding hierarchical stage. In the early/beginning stages in the hierarchical approach, the minimization framework may assign higher/highest weight to the soft data. As the resolution is increased, the minimization framework may assign higher/highest weight to the hard data. The training may be repeated for a specific number of epochs for individual stages until the loss function is minimized.

Inputs to the hierarchical training process may include conditioning data (hard and/or soft data, such as rock types) and input subsurface representation. The resolution of the conditioning data and the input subsurface representation may be changed (e.g., reduced, increased, scaled) to fit the resolution of different stages of training. For example, in FIG. 4, the resolution of the conditioning data and the input subsurface representation may be changed to generate low-resolution conditioning data 414 and low-resolution input subsurface representation 418 for stage two of the hierarchical training, mid-resolution conditioning data 424 and mid-resolution input subsurface representation 428 for stage one of the hierarchical training, and high-resolution conditioning data 434 and high-resolution input subsurface representation 438 for stage three of the hierarchical training.

At different stages/resolutions, different types of subsurface features/subsurface features of different sizes/scales may be honored using the conditioning data. For example, in stage one (coarse stage), seismic data and low-resolution subsurface features may be honored using the conditioning framework in the latent space. In stage two (intermediate stage), productivity indexes and rock types may be honored using the conditioning framework in the latent space. In stage three (final stage), subsurface heterogeneities may be honored using the conditioning framework in the latent space.

In stage one, random noise 412 (low resolution) and the low-resolution conditioning data 414 may be used by the generator 402 to generate a low-resolution output subsurface representation 416. The low-resolution output subsurface representation 416 and the low-resolution input subsurface representation 418 may be input to the discriminator 404 for classification. The low-resolution input subsurface representation 418 may be used as a positive example during training. The discriminator 404 may classify the low-resolution output subsurface representation 416 and the low-resolution input subsurface representation 418. The discriminator loss function may penalize the discriminator 404 for misclassification (misclassifying the low-resolution input subsurface representation 418 as being fake; misclassifying the low-resolution output subsurface representation 416 as being real). The generator loss function may penalize the generator 402 for failing to generate the low-resolution output subsurface representation 416 that fools the discriminator 404. The classification by the discriminator 404 may be used to select and/or modify the hyperparameters of the generative adversarial network.

Once stage one of the hierarchical training is finished, the low-resolution output subsurface representation 416, random noise 422 (mid resolution), and the mid-resolution conditioning data 424 may be used by the generator 402 to generate a mid-resolution output subsurface representation 426. The low-resolution output subsurface representation 416 may be upscaled to match the resolution of the mid-resolution conditioning data 424. The low-resolution output subsurface representation 416 and the random noise 422 may be concatenated and passed into the generator 402. The mid-resolution output subsurface representation 426 and the mid-resolution input subsurface representation 428 may be input to the discriminator 404 for classification. The classification by the discriminator 404 may be used to select and/or modify the hyperparameters of the generative adversarial network.

Once stage two of the hierarchical training is finished, the mid-resolution output subsurface representation 426, random noise 432 (high resolution), and the high-resolution conditioning data 434 may be used by the generator 402 to generate a high-resolution output subsurface representation 436. The mid-resolution output subsurface representation 426 may be upscaled to match the resolution of the high-resolution conditioning data 434. The mid-resolution output subsurface representation 426 and the random noise 432 may be concatenated and passed into the generator 402. The high-resolution output subsurface representation 436 and the high-resolution input subsurface representation 438 may be input to the discriminator 404 for classification. The classification by the discriminator 404 may be used to select and/or modify the hyperparameters of the generative adversarial network.

Once hierarchical training is finished, random noise may be used by the trained generative adversarial network to generate subsurface representations that include geological and physical consistency learned from the input subsurface representation while honoring conditioning data (e.g., rock types, seismic data, production data). Hierarchical training of the machine learning model may ensure that the subsurface representation generated by the machine learning model honors data at different levels of resolution. Hierarchical training of the machine learning model may ensure that the subsurface representation generated by the machine learning model honors different scales of variability and heterogeneity in the subsurface region. Subsurface features of different sizes/scales are incorporated into the machine learning model at different stages of hierarchical training. Without hierarchical training, the machine learning model may generate unrealistic subsurface representations. For example, subsurface representations may include correct fine-scale details but incorrect coarse-scale details.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate hierarchical machine learning training for subsurface modeling. The machine-readable instructions 100 may include one or more computer program components. The machine-readable instructions 100 may include a conditioning component 102, an input subsurface representation component 104, a train component 106, an output subsurface representation component 108, a modeling component 110, and/or other computer program components.

The conditioning component 102 may be configured to obtain conditioning information and/or other information. Obtaining conditioning information may include one or more of accessing, acquiring, analyzing, creating, determining, examining, generating, identifying, loading, locating, measuring, opening, receiving, retrieving, reviewing, selecting, storing, utilizing, and/or otherwise obtaining the conditioning information. The conditioning component 102 may obtain conditioning information from one or more locations. For example, the conditioning component 102 may obtain conditioning information from a storage location, such as the electronic storage 13, electronic storage of a device accessible via a network, and/or other locations. The conditioning component 102 may obtain conditioning information from one or more hardware components (e.g., a computing device, a component of a computing device) and/or one or more software components (e.g., software running on a computing device). Conditioning information may be stored within a single file or multiple files.

The conditioning information may define one or more conditioning characteristics within a subsurface region. The conditioning information may define conditioning characteristics as a function of location (e.g., vertical spatial location, such as depth; lateral spatial location, such as x-y coordinate in map view) within the subsurface region. A subsurface region may refer to a part of earth located beneath the surface/located underground. A subsurface region may refer to a part of earth that is not exposed at the surface of the ground. A subsurface region may be defined in a single dimension (e.g., a point, a line) or in multiple dimensions (e.g., a surface, a volume).

A conditioning characteristic may refer to subsurface feature, property, quantity, and/or quality of the subsurface region that is desired to be preserved within a subsurface representation. A conditioning characteristic may refer to a characteristic of the subsurface region that is to be preserved with a subsurface representation. Conditioning characteristics may define guides/constraints and/or fixed points in generating subsurface representations. Conditioning characteristics may include subsurface feature, property, quantity, and/or quality of one or more subsurface points, areas, and/or volumes of interest. Conditioning characteristics may include hard data, soft data, and/or other data. In some implementations, conditioning characteristics may include geological characteristics, petrophysical characteristics, geophysical characteristics, seismic characteristics, and/or other subsurface characteristics.

For example, conditioning characteristics may include one or more rock properties (e.g., rock types, layers, grain sizes, porosity, permeability) that are to be preserved within subsurface representations and/or to be used as guides/constraints in generating subsurface representations. The rock properties may define fixed points from which subsurface representations are generated. Usage of other subsurface properties as conditioning characteristics are contemplated.

The conditioning information may define a conditioning characteristic by including information that describes, delineates, identifies, is associated with, quantifies, reflects, sets forth, and/or otherwise defines one or more of content, quality, attribute, feature, and/or other aspects of the conditioning characteristic. For example, the conditioning information may define a conditioning characteristic by including information that makes up the conditioning characteristic and/or information that is used to identify/determine the conditioning characteristic. Other types of conditioning information are contemplated.

In some implementations, the condition information may define conditioning characteristics at one or more points, one or more lines, one or more surfaces, one or more laterals/rows, one or more verticals/columns, and/or one or more volumes within a subsurface region. Conditioning characteristics may be defined at other locations within a subsurface region.

In some implementations, conditioning information may include information from field exploration of the subsurface region, seismic exploration of the subsurface region, and/or production in the subsurface region. For example, conditioning information may include information obtained and/or derived from field exploration of the subsurface region, seismic exploration of the subsurface region, and/or production in the subsurface region. For instance, conditioning information may include information from seismic maps, well logs, and/or production data.

In some implementations, the conditioning information may be determined based on one or more well logs, interpreted seismic information (including data or data sets), and/or other information. For example, the conditioning information may include information obtained from borehole logging of the well and may include a record of geologic formations penetrated by a borehole (e.g., geologic formations within/surrounding the well). The conditioning information may include information obtained from well cores (e.g., rock samples collected as part of drilling process) and/or other seismic information. The well cores/seismic information may provide information on one or more properties of the drilled rocks, such as rock types, layers, grain sizes, porosity, and/or permeability. For example, conditioning characteristics may include and/or may be determined based on rock types, layers, grain sizes, porosity, and/or permeability of one or more wells of interest.

The input subsurface representation component 104 may be configured to obtain input subsurface representation information and/or other information. Obtaining input subsurface representation information may include one or more of accessing, acquiring, analyzing, creating, determining, examining, generating, identifying, loading, locating, measuring, opening, receiving, retrieving, reviewing, selecting, storing, utilizing, and/or otherwise obtaining the input subsurface representation information. The input subsurface representation component 104 may obtain input subsurface representation information from one or more locations. For example, the input subsurface representation component 104 may obtain input subsurface representation information from a storage location, such as the electronic storage 13, electronic storage of a device accessible via a network, and/or other locations. The input subsurface representation component 104 may obtain input subsurface representation information from one or more hardware components (e.g., a computing device, a component of a computing device) and/or one or more software components (e.g., software running on a computing device). Input subsurface representation information may be stored within a single file or multiple files.

The input subsurface representation information may define one or more input subsurface representations for modeling of the subsurface region. The input subsurface representation information may define an input subsurface representation by including information that describes, delineates, identifies, is associated with, quantifies, reflects, sets forth, and/or otherwise defines one or more of content, quality, attribute, feature, and/or other aspects of the subsurface representation. For example, the input subsurface representation information may define an input subsurface representation by including information that makes up the content of the input subsurface representation and/or information that is used to identify/determine the content of the input subsurface representation. Other types of input subsurface representation information are contemplated.

An input subsurface representation may refer to a subsurface representation to be used as input for hierarchical training of machine learning model. A subsurface representation may refer to a computer-generated representation of a subsurface region, such as a one-dimensional, two-dimensional and/or three-dimensional model of the subsurface region. A subsurface representation may be representative of the depositional environment where wells are located. A subsurface representation may include geologically plausible arrangement of rock obtained from a modeling process (e.g., stratigraphic forward modeling process). A subsurface representation may define simulated subsurface configuration within a simulated subsurface region. A subsurface representation may define simulated subsurface configuration at different locations within a simulated subsurface region.

Simulated subsurface configuration may refer to subsurface configuration simulated within a subsurface representation. A simulated subsurface region may refer to a subsurface region simulated within a subsurface representation. That is, a subsurface representation may define subsurface configuration of a subsurface region simulated by one or more subsurface models. A subsurface representation may be used as and/or may be referred to as a digital analog.

A subsurface model may refer to a computer model (e.g., program, tool, script, function, process, algorithm) that generates subsurface representations. A subsurface model may simulate subsurface configuration within a region underneath the surface (subsurface region). Subsurface configuration may refer to attribute, quality, and/or characteristics of a subsurface region. Subsurface configuration may refer to physical arrangement of materials (e.g., subsurface elements) within a subsurface region. Examples of subsurface configuration simulated by a subsurface model may include types of subsurface materials, characteristics of subsurface materials, compositions of subsurface materials, arrangements/configurations of subsurface materials, physics of subsurface materials, and/or other subsurface configuration. For instance, subsurface configuration may include and/or define types, shapes, and/or properties of materials and/or layers that form subsurface (e.g., geological, petrophysical, geophysical, stratigraphic) structures.

An example of a subsurface model is a computational stratigraphy model. A computational stratigraphy model may refer to a computer model that simulates depositional and/or stratigraphic processes on a grain size scale while honoring physics-based flow dynamics. A computational stratigraphy model may simulate rock properties, such as velocity and density, based on rock-physics equations and assumptions. Input to a computational stratigraphy model may include information relating to a subsurface region to be simulated. For example, input to a computational stratigraphy model may include paleo basin floor topography, paleo flow and sediment inputs to the basin, and/or other information relating to the basin. In some implementations, input to a computational stratigraphy model may include one or more paleo geologic controls, such as climate changes, sea level changes, tectonics and other allocyclic controls. Output of a computational stratigraphy model may include one or more subsurface representations. A subsurface representation generated by a computational stratigraphy model may be referred to as a computational stratigraphy model representation.

A computational stratigraphy model may include a forward stratigraphic model. A forward stratigraphic model may be an event-based model, a process mimicking model, a reduced physics-based model, and/or a fully physics-based model (e.g., fully based on physics of flow and sediment transport). A forward stratigraphic model may simulate one or more sedimentary processes that recreate the way stratigraphic successions develop and/or are preserved. The forward stratigraphic model may be used to numerically reproduce the physical processes that eroded, transported, deposited and/or modified the sediments over variable time periods. In a forward modelling approach, data may not be used as the anchor points for facies interpolation or extrapolation. Rather, data may be used to test and validate the results of the simulation. Stratigraphic forward modelling may be an iterative approach, where input parameters are modified until the results are validated by actual data. Usage of other subsurface models and other subsurface representations are contemplated.

A subsurface representation may be representative of a subsurface region of interest. For example, the simulated subsurface configuration defined by a subsurface representation may be representative of the subsurface configuration of a reservoir of interest. Other subsurface regions of interest are contemplated. In some implementations, a subsurface representation may be scaled in area size and thickness to match a subsurface region of interest. For example, lateral size and/or vertical depth of a subsurface representation may be changed to be comparable to the size and thickness of a subsurface region of interest.

The train component 106 may be configured to hierarchically train one or more machine learning models. A machine learning model may be trained using the conditioning characteristic(s), the input subsurface representation(s), and/or other information to generate one or more subsurface representations. Training a machine learning model may include facilitating learning by the machine learning model by processing the conditioning characteristic(s), the input subsurface representation(s), and/or other information with the machine learning model to generate subsurface representations. For example, the machine learning model may include a generative neural network. The generative neural network may include a generator and a discriminator. An input subsurface representation may be used as an example of output to be generated by the generator. The conditioning characteristics may be used to guide/constrain the generation of subsurface representations by the generator. The machine learning model may be trained until a threshold accuracy is reached by the generator in producing output (e.g., trained until the discriminator cannot distinguish between input subsurface representations and subsurface representations generated by the generator).

The trained machine learning(s) may be stored in a storage medium (e.g., one or more non-transitory storage media and/or other storage media). For example, the trained machine learning model(s)/information defining the trained machine learning model(s) may be stored in in a storage location, such as the electronic storage 13, electronic storage of a device accessible via a network, and/or other locations. The trained machine learning model(s) may be stored for use in generating subsurface representations. The trained machine learning model(s) may be stored for retrieval/running when generating subsurface representations.

Hierarchical training of a machine learning model may include training of the machine learning model in a sequence using progressively higher resolution. Hierarchical training of a machine learning model may refer to training of the machine learning model in an order. Hierarchical training of a machine learning model may refer to training of the machine learning model in an order of resolution, starting with the lowest resolution and ending with the highest resolution. Hierarchical training of a machine learning model may include training of the machine learning model in stages, with individual stages including use of progressively higher resolutions. For example, hierarchical training of a machine learning model may include a first stage in which the machine learning model is trained using the conditioning characteristic(s) and an input subsurface representation with a first resolution, a second stage subsequent to the first stage in which the machine learning model is trained using the conditioning characteristic(s) and the input subsurface representation with a second resolution higher than the first resolution, and/or other stages. Use of other number of stages is contemplated.

For example, FIG. 4 illustrates an example hierarchical training of a machine learning model with three stages, with the resolution of data used to train the machine learning model progressively increasing with each stage, from low-resolution to mid-resolution to high-resolution. Other number of stages and use of other resolutions are contemplated.

In some implementations, different resolutions used in the hierarchical training of the machine learning model may correspond to sizes of different subsurface features. The resolutions of different stages may be selected to target/highlight subsurface features of particular sizes (scales). For example, in an early stage of the hierarchical training, the resolution used may target/highlight large subsurface features in the training data. In a later stage of the hierarchical training, the resolution used may target/highlight fine subsurface features in the training data.

In some implementations, the machine-learning model may be partially trained after completion of a stage of the hierarchical training. An output of the partially trained machine learning model may be used as an input for the subsequent stage of the hierarchical training. For example, in FIG. 4, after stage one, the partially trained machine learning model may be used to generate an output subsurface representation. The output subsurface representation generated by the partially trained machine learning model may be used as input to the hierarchical training in the next stage.

The output subsurface representation component 108 may be configured to generate one or more output subsurface representations for modeling of the subsurface region using the trained machine learning model. After the hierarchical training of the machine learning model, the machine learning model may be used to generate one or more output subsurface representations. In some implementations, random noise may be input into the trained machine learning model to generate the output subsurface representation(s). Random noise may be input into the trained machine learning model, and the trained machine learning model may use the random noise to generate the output subsurface representation(s). The output subsurface representation(s) may be generated for modeling of the subsurface region.

The output subsurface representation(s) generated by the trained machine learning model may include geologically realistic subsurface configuration. The output subsurface representation(s) generated by the trained machine learning model may include realistic geological patterns/heterogeneity learned from the input subsurface representation. For example, referring to FIG. 3, the output subsurface representation(s) generated by the trained machine learning model may include realistic geological patterns/heterogeneity learned from the input subsurface representation 302. Referring to FIG. 4, the output subsurface representation(s) generated by the trained machine learning model may include realistic geological patterns/heterogeneity learned from the low-resolution input subsurface representation 418, the mid-resolution input subsurface representation 428, and the high-resolution input subsurface representation 438 used to train the machine learning model.

The output subsurface representation(s) generated by the trained machine learning model may honor the conditioning characteristic(s) within the subsurface region. An output subsurface representation honoring the conditioning characteristic(s) within the subsurface region may include the output subsurface representation matching the conditioning characteristic(s) within the subsurface region. An output subsurface representation honoring the conditioning characteristic(s) within the subsurface region may include the subsurface configuration of the output subsurface representation having the same condition characteristic(s) at the corresponding location(s). An output subsurface representation honoring a conditioning characteristic within the subsurface region may include the characteristic of the output subsurface representation at the corresponding location being the same the conditioning characteristic within the subsurface region. An output subsurface representation honoring a conditioning characteristic within the subsurface region may include the characteristic of the output subsurface representation at the corresponding location being within a threshold value of the conditioning characteristic within the subsurface region.

The output subsurface representation(s) generated by the trained machine learning model may honor the conditioning characteristic(s) within the subsurface region that were used to train the machine learning model. For example, referring to FIG. 3, the output subsurface representation(s) generated by the trained machine learning model may honor the conditioning characteristics 304. Referring to FIG. 4, the output subsurface representation(s) generated by the trained machine learning model may honor the low-resolution conditioning data 414, the mid-resolution conditioning data 424, and the high-resolution conditioning data 434 used to train the machine learning model.

The modeling component 110 may be configured to perform modeling of the subsurface region based on the output subsurface representation(s) and/or other information. Modeling of the subsurface region may include generation of one or more subsurface representations for the subsurface region. Modeling of the subsurface region may include use of subsurface representation(s) for the subsurface region to facilitate planning, development, production, and/or risk assessment of the subsurface region. Modeling of the subsurface region may include simulation of subsurface configuration of the subsurface region at particular moment(s) in time and/or for duration(s) of time (e.g., simulation of how subsurface configurations change within a subsurface region over time). Modeling of the subsurface region may include use of subsurface representation(s) for the subsurface region to simulate changes in the subsurface region during development (e.g., drilling of wells, completion of wells) and/or production (e.g., recovery of hydrocarbons from wells). Modeling of the subsurface region based on the output subsurface representation(s) may be more accurate and/or reliable than modeling using other methods/models as the output subsurface representation(s) include geologically realistic subsurface configuration while honoring the conditioning characteristic(s) within the subsurface region.

In some implementations, the output subsurface representation(s) generated by the trained machine learning model may be used as the subsurface representation(s) of the subsurface region. In some implementations, the output subsurface representation(s) generated by the trained machine learning model may be used to generate the subsurface representation(s) of the subsurface region. The performance of the modeling of the subsurface region based on the output subsurface representation(s) may generate one or more geologically realistic subsurface representations for the subsurface region that honor the conditioning characteristic(s) within the subsurface region at multiple levels of resolution.

For example, a facies probability cube for the subsurface region may be generated based on multiple output subsurface representations generated by the trained machine learning model and/or other information. A facies probability cube may refer to a geological model (e.g., 3D geological model) that represents the likelihood of different sedimentary facies (rock types) occurring at different locations. A facies probability cube may provide a probability distribution for each facies throughout the subsurface region. The number of occurrences of different sedimentary facies at a particular location across multiple output subsurface representations may be used to generate the facies probability cube. Different facies probability cubes may be generated for different types of rock types and used to perform subsurface modeling. Other types of probability cubes may be generated for other characteristics of the subsurface region based on multiple output subsurface representations and used to perform subsurface modeling.

Performance of the modeling of the subsurface region based on the output subsurface representation(s) may include performance of the modeling of the subsurface region based on the facies probability cube(s) for the subsurface region. For example, the modeling of the subsurface region may be performed using a multiple-point statistics simulation and/or other geostatistical simulation (e.g., sequential Gaussian simulation, sequential indicator simulation) of the subsurface region. The facies probability cube(s) generated from the multiple output subsurface representations may be used as input to the multiple-point statistics simulation.

The modeling of the subsurface region may be used for field development plans, well placement, assessing risks in the subsurface region, and/or production. For example, production in the subsurface region may be facilitated based on the modeling of the subsurface region and/or other information. For example, the modeling of the subsurface region may be used for forecasting production, planning/controlling well operations (e.g., waterflooding, pressure management).

As used herein, the phrase “configured to” is intended to be interpreted broadly, as “being capable of or suitable for performing” some function or feature, without requiring any adaptations to provide said function or feature.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

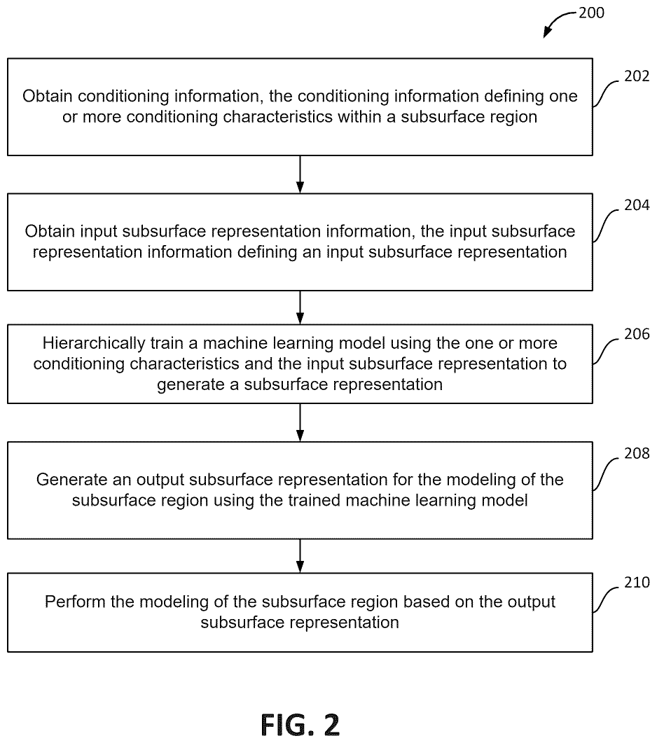

FIG. 2 illustrates method 200 for hierarchical machine learning training for subsurface modeling. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software for execution of one or more of the operations of method 200.

At operation 202, conditioning information may be obtained. The conditioning information may define one or more conditioning characteristics within a subsurface region. In some implementations, operation 202 may be performed by a processor component the same as or similar to the conditioning component 102 (Shown in FIG. 1 and described herein).

At operation 204, input subsurface representation information may be obtained. The input subsurface representation information may define an input subsurface representation for modeling of the subsurface region. The input subsurface representation may define simulated subsurface configuration within a simulated subsurface region. In some implementations, operation 204 may be performed by a processor component the same as or similar to the input subsurface representation component 104 (Shown in FIG. 1 and described herein).

At operation 206, a machine learning model may be hierarchically trained using the conditioning characteristic(s) and the input subsurface representation to generate a subsurface representation. The hierarchical training of the machine learning model may include training of the machine learning model in a sequence using progressively higher resolution. The hierarchical training of the machine learning model may include a first stage in which the machine learning model is trained using the conditioning characteristic(s) and the input subsurface representation with a first resolution and a second stage subsequent to the first stage in which the machine learning model is trained using the conditioning characteristic(s) and the input subsurface representation with a second resolution higher than the first resolution. In some implementations, operation 206 may be performed by a processor component the same as or similar to the train component 106 (Shown in FIG. 1 and described herein).

At operation 208, an output subsurface representation for the modeling of the subsurface region may be generated using the trained machine learning model. The output subsurface representation generated by the trained machine learning model may honor the conditioning characteristic(s) within the subsurface region. In some implementations, operation 208 may be performed by a processor component the same as or similar to the output subsurface representation component 108 (Shown in FIG. 1 and described herein).

At operation 210, the modeling of the subsurface region may be performed based on the output subsurface representation and/or other information. In some implementations, operation 210 may be performed by a processor component the same as or similar to the modeling component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for hierarchical machine learning training for subsurface modeling, the system comprising:
one or more physical processors configured by machine-readable instructions to:
obtain conditioning information, the conditioning information defining one or more conditioning characteristics within a subsurface region;
obtain input subsurface representation information, the input subsurface representation information defining an input subsurface representation for modeling of the subsurface region, the input subsurface representation defining simulated subsurface configuration within a simulated subsurface region;
hierarchically train a machine learning model using the one or more conditioning characteristics and the input subsurface representation to generate a subsurface representation, the hierarchical training of the machine learning model including training of the machine learning model in a sequence using progressively higher resolution, wherein the hierarchical training of the machine learning model includes a first stage in which the machine learning model is trained using the one or more conditioning characteristics and the input subsurface representation with a first resolution and a second stage subsequent to the first stage in which the machine learning model is trained using the one or more conditioning characteristics and the input subsurface representation with a second resolution higher than the first resolution;
generate an output subsurface representation for the modeling of the subsurface region using the trained machine learning model, wherein the output subsurface representation generated by the trained machine learning model honors the one or more conditioning characteristics within the subsurface region; and
perform the modeling of the subsurface region based on the output subsurface representation.

2. The system of claim 1, wherein the machine learning model includes a generative neural network.

3. The system of claim 1, wherein different resolutions used in the hierarchical training of the machine learning model correspond to sizes of different subsurface features.

4. The system of claim 1, wherein:
multiple output subsurface representations are generated for the modeling of the subsurface region using the trained machine learning model;
a facies probability cube for the subsurface region is generated based on the multiple output subsurface representations; and
performance of the modeling of the subsurface region based on the output subsurface representation includes performance of the modeling of the subsurface region based on the facies probability cube for the subsurface region.

5. The system of claim 1, wherein the modeling of the subsurface region is performed using a multiple-point statistics simulation.

6. The system of claim 1, wherein:
the machine-learning model is partially trained after completion of the first stage of the hierarchical training; and
an output of the partially-trained machine learning model is used as an input for the second stage of the hierarchical training.

7. The system of claim 1, wherein random noise is input into the trained machine learning model to generate the output subsurface representation.

8. The system of claim 1, wherein the conditioning information includes information from field exploration of the subsurface region, seismic exploration of the subsurface region, and/or production in the subsurface region.

9. The system of claim 1, wherein production in the subsurface region is facilitated based on the modeling of the subsurface region.

10. The system of claim 1, wherein performance of the modeling of the subsurface region based on the output subsurface representation generates a geologically realistic subsurface representation for the subsurface region that honors the one or more conditioning characteristics within the subsurface region at multiple levels of resolution.

11. A method for hierarchical machine learning training for subsurface modeling, the method comprising:
obtaining conditioning information, the conditioning information defining one or more conditioning characteristics within a subsurface region;
obtaining input subsurface representation information, the input subsurface representation information defining an input subsurface representation for modeling of the subsurface region, the input subsurface representation defining simulated subsurface configuration within a simulated subsurface region;
hierarchically training a machine learning model using the one or more conditioning characteristics and the input subsurface representation to generate a subsurface representation, the hierarchical training of the machine learning model including training of the machine learning model in a sequence using progressively higher resolution, wherein the hierarchical training of the machine learning model includes a first stage in which the machine learning model is trained using the one or more conditioning characteristics and the input subsurface representation with a first resolution and a second stage subsequent to the first stage in which the machine learning model is trained using the one or more conditioning characteristics and the input subsurface representation with a second resolution higher than the first resolution;
generating an output subsurface representation for the modeling of the subsurface region using the trained machine learning model, wherein the output subsurface representation generated by the trained machine learning model honors the one or more conditioning characteristics within the subsurface region; and
performing the modeling of the subsurface region based on the output subsurface representation.

12. The method of claim 11, wherein the machine learning model includes a generative neural network.

13. The method of claim 11, wherein different resolutions used in the hierarchical training of the machine learning model correspond to sizes of different subsurface features.

14. The method of claim 11, wherein:
multiple output subsurface representations are generated for the modeling of the subsurface region using the trained machine learning model;
a facies probability cube for the subsurface region is generated based on the multiple output subsurface representations; and
performing the modeling of the subsurface region based on the output subsurface representation includes performing the modeling of the subsurface region based on the facies probability cube for the subsurface region.

15. The method of claim 11, wherein the modeling of the subsurface region is performed using a multiple-point statistics simulation.

16. The method of claim 11, wherein:
the machine-learning model is partially trained after completion of the first stage of the hierarchical training; and
an output of the partially-trained machine learning model is used as an input for the second stage of the hierarchical training.

17. The method of claim 11, wherein random noise is input into the trained machine learning model to generate the output subsurface representation.

18. The method of claim 11, wherein the conditioning information includes information from field exploration of the subsurface region, seismic exploration of the subsurface region, and/or production in the subsurface region.

19. The method of claim 11, wherein production in the subsurface region is facilitated based on the modeling of the subsurface region.

20. The method of claim 11, wherein performing the modeling of the subsurface region based on the output subsurface representation generates a geologically realistic subsurface representation for the subsurface region that honors the one or more conditioning characteristics within the subsurface region at multiple levels of resolution.
